(19) United States
(12) Patent Application Publication
(10) Pub. No.: US 2007/0230418 A1
(43) Pub. Date: Oct. 4, 2007

(54) Triggering rule for energy efficient data delivery

(75) Inventors: Shojiro Takeuchi, Tokyo (JP); Toshiaki Jozawa, Tokyo (JP); Leping Huang, Kanagawa (JP); Tomokazu Sakai, Kanagawa (JP)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/395,566

(22) Filed: Mar. 31, 2006

(51) Int. Cl. H04Q 7/24

(52) U.S. Cl. 370/338; 370/412

(57) ABSTRACT

A new and unique method or apparatus for implementing an unscheduled automatic power save delivery (U-APSD) in a wireless local area network (WLAN) terminal, comprising maintaining a timer for defining a triggering interval between sending of subsequent trigger frames to a WLAN access point, wherein the value of the timer is set to dynamically change according to one or more criteria relating to the current communication situation. The criteria depend on whether there are buffered frames. at another node, point, terminal or device, such as an Access Point (AP)), in the wireless local area network (WLAN), or other suitable network. For example, when there are buffered frames at the AP, the WLAN terminal sets the triggering interval to a minimum value and sends null-data frames to quickly retrieve them, or when there is no buffered frame at the AP, the STA sets the triggering interval to a larger value to continue the doze mode for a long time and to save energy. The WLAN terminal incrementally increases the triggering interval in a binary exponential fashion, including doubling it, but not exceeding a maximum value.

### BACKGROUND OF THE INVENTION

1. Field of Invention

The present invention relates to a wireless local area network (WLAN) environment, and more particularly provides a method and system for optimizing data reception and power saving for mobile terminals operating in the WLAN environment.

2. Description of Related Art

FIG. 1 shows, by way of example, typical parts of an IEEE 802.11 WLAN system, which is known in the art and provides for communications between communications equipment such as mobile and secondary devices including personal digital assistants (PDAs), laptops and printers, etc. The WLAN system may be connected to a wired LAN system that allows wireless devices to access information and files on a file server or other suitable device or connecting to the Internet.

The devices can communicate directly with each other in the absence of a base station in a so-called “ad-hoc” network, or they can communicate through a base station, called an access point (AP) in IEEE 802.11 terminology, with distributed services through the AP using local distributed services (DS) or wide area extended services, as shown. In a WLAN system, end user access devices are known as stations (STAs), which are transceivers (transmitters/receivers) that convert radio signals into digital signals that can be routed to and from communications device and connect the communications equipment to access points (APs) that receive and distribute data packets to other devices and/or networks. The STAs may take various forms ranging from wireless network interface card (NIC) adapters coupled to devices to integrated radio modules that are part of the devices, as well as an external adapter (USB), a PCMCIA card or a USB Dongle (self contained), which are all known in the art.

FIGS. 2a and 2b show diagrams of the Universal Mobile Telecommunications System (UMTS) packet network architecture, which is also known in the art. In FIG. 2a, the UMTS packet network architecture includes the major architectural elements of user equipment (UE), UMTS Terrestrial Radio Access Network (UTRAN), and core network (CN). The UE is interfaced to the UTRAN over a radio (Uu) interface, while the UTRAN interfaces to the core network (CN) over a (wired) Iu interface. FIG. 2b shows some further details of the architecture, particularly the UTRAN, which includes multiple Radio Network Subsystems (RNSs), each of which contains at least one Radio Network Controller (RNC). In operation, each RNC may be connected to multiple Node Bs which are the UMTS counterparts to GSM base stations. Each Node B may be in radio contact with multiple UEs via the radio interface (Uu) shown in FIG. 2a. A given UE may be in radio contact with multiple Node Bs even if one or more of the Node Bs are connected to different RNCs. For instance, a UE1 in FIG. 2b may be in radio contact with Node B2 of RNS1 and Node B3 of RNS2 where Node B2 and Node B3 are neighboring Node Bs. The RNCs of different RNSs may be connected by an Iur interface which allows mobile UEs to stay in contact with both RNCs while traversing from a cell belonging to a Node B of one RNC to a cell belonging to a Node B of another RNC. The convergence of the IEEE 802.11 WLAN system in FIG. 1 and the (UMTS) packet network architecture in FIGS. 2a and 2b has resulted in STAs taking the form of UEs, such as mobile phones or mobile terminals. The interworking of the WLAN (IEEE 802.11) shown in FIG. 1 with such other technologies (e.g. 3GPP, 3GPP2 or 802.16) such as that shown in FIGS. 2a and 2b is being defined at present in protocol specifications for 3GPP and 3GPP2.

In recent years, wireless LAN technology has become very popular because of its advantage in price and bandwidth. Nowadays, wireless LAN is mainly used for Internet access, but real-time application like Voice over IP (VoIP) and video on demand (Vod) are identified as the future applications for wireless LAN. To support such new applications, IEEE 802.11e was standardized to define a new 802.11 medium access control (MAC) layer protocol. The IEEE802.11e MAC is a standard to support Quality of Service (QoS). 802.11e Hybrid Coordination Function (HCF) can support QoS in 802.11 networks. The HCF provides both a contention-based channel access, called enhanced distributed channel access (EDCA), and a controlled channel access, referred to as HCF controlled channel access (HCCA).

Handheld devices having IEEE 802.11 WLAN can provide wireless broadband access. However, since they are generally battery-powered, power consumption is a critical issue for mobile terminals equipped with IEEE 802.11 WLAN. Therefore IEEE 802.11 provides a power saving mechanism (LegacyPS) for STAs to reduce power consumption. Furthermore, IEEE 802.11e supports scheduled and unscheduled automatic power save delivery (S-APSD and U-APSD) to enhance the power saving mechanism in LegacyPS. An STA can determine which power saving mechanism it uses.

U-APSD is a power saving method that will be (and already is) implemented by most WLAN modem vendors. In U-APSD, the terminal (STA) initially informs the access point (AP) that it will use U-APSD, which means that the AP will buffer downlink data intended to the STA until it receives a triggering frame from the STA, which indicates to the AP that the STA is awake and a Service Period (U-APSD SP) can be started. In U-APSD SP, the AP transmits the buffered data to the STA, which is required to stay active until receiving a service period end indication from the AP and send an acknowledgment to that, after which it can enter doze/power saving state.

Under EDCA, U-APSD can achieve energy-efficient transmission because it reduces awake-period compared to LegacyPS. U-APSD has to transmit uplink frames in order to retrieve frames buffered at Quality of Service (QoS) Access Point (QAP). Those uplink frames are called trigger frames. In the case where an STA has uplink data frames (i.e. connection is bi-directional), U-APSD can save energy. However, when it does not have uplink data frames generated at a constant rate (for example, ON-OFF traffic), it has to send a null-data frame to retrieve frames buffered at QAP. When there is no uplink frame and null-data frames rarely are transmitted to the QAP, large delay and low throughput occurs even if energy can be saved. On the contrary, when there are little buffered frames at the QAP and many null-data frames are transmitted as trigger-frames, energy will be wasted. Therefore trade-off between delay (throughput) and energy consumption must be considered to send trigger frames. Although IEEE 802.11e standard has defined basic operation of U-APSD, how and when to start transmission of trigger frames are still dependent on vendor's implementation.

The following prior art documents describe, by way of example, the general operation of IEEE 802.11e Unscheduled Automatic Power Save Delivery (U-APSD) communication, as follows:

United States publication no. 2005/0136914 discloses a power management method for creating deliver opportunities in a wireless communication system, in which the creation of delivery opportunities for a wireless station (STA) of a WLAN system is managed using a designated sub-field of the frame control field in a MAC header. In one embodiment, the STA is adapted (i) to use the power management sub-field to communicate its power state to the access point (AP) and (ii) to run a periodicity timer, which starts when the STA has transitioned to the doze state. The STA transitions to the awake state either when it has a data frame available for transmission to the AP or when the periodicity timer runs out. In another embodiment, the AP and STA create deliver opportunities by entering a new mode of operation referred to as interactive traffic power management (ITPM) mode, during which the power management sub-field is ignored and the more data sub-field is used to communicate the power state and manage transitions of the STA between the awake and doze states.

Alternatively, United States publication no. US 2005/0136913 discloses a power management method for managing deliver opportunities in a wireless communication system, in which duration of deliver opportunities for a wireless station (STA) of a WLAN system is managed using a designated sub-field of the frame control field in a MAC header. Either the STA or the access point (AP) can terminate the deliver opportunity, e.g., based on the amount traffic. In one embodiment, the STA is adapted (i) to use the power management sub-field to communicate its power state to the AP and (ii) to run a maximum-wait timer, which starts when the AP is informed that the STA is in the awake state. The STA transitions to the doze state either when it has received a data frame from the AP or when the maximum-wait timer runs out. In another embodiment, the AP and STA manage deliver opportunities by entering a new mode of operation referred to as interactive traffic power management (ITPM) mode. During this mode the power management sub-field is ignored and the more data sub-field is used to communicate the availability of data and to manage transitions of the STA between the awake and doze states. United States publication no. 2005/0136914 and US 2005/0136913 may improve WLAN system performance when the traffic load is such that data frames become available for transmission both at the STA and AP at relatively regular intervals, which is typically the case for interactive voice-over-WLAN applications.

European patent application no. EP 1583285 discloses a delivery of buffered frames to power saving stations in wireless local area networks, which includes a method and apparatus for conveying priority of buffered frames to power saving stations in a Wireless Local Area Network (WLAN) including an Access Point (AP) and at least one power saving station is presented. The method and apparatus indicate to a station the presence of at least one buffered frame in at least one of legacy buffers and Automatic Power Save Delivery (APSD) buffers in the AP for the station. The AP receives an indication from the station that the station is ready to receive at least one of the buffered frames for the station. The AP then selects a buffer for releasing at least one buffered frame to the station, determines a number of frames to transmit from the selected buffer, and transmits the number of frames from said buffer to the station.

In summary, the following documents do not disclose the actual decision intelligence for the mobile station (STA) for performing adaptive trigger frame scheduling for optimizing data throughput vs. terminal power saving ratio for terminal communication. In view of this, there is a need for a rule of trigger frame transmission to achieve energy-efficient data delivery especially for STAs operating according to the U-APSD.

### SUMMARY OF THE INVENTION

The present invention provides a new and unique method and apparatus for implementing an unscheduled service period (U-SP) in a node, point, terminal or device, such as a station (STA), in a wireless local area network (WLAN), or other suitable network, featuring one or more steps for periodically providing a triggering signal based on a variable triggering interval. The U-SP may include an unscheduled automatic power save delivery (U-APSD) as defined in IEEE 802.11e.

The variable triggering interval may depend on whether there are buffered frames at another node, point, terminal or device, such as an Access Point (AP), in the wireless local area network (WLAN), or other suitable network. For example, after noticing that there are buffered frames at the AP, the STA sets the triggering interval to a minimum value and sends null-data frames to quickly retrieve them, or when there is no buffered frame at the AP, the STA sets the triggering interval to a larger value to continue the doze mode for a longer time to save energy.

The STA may incrementally increase the triggering interval in a binary exponential fashion, including doubling it, but not to exceed a maximum value.

The triggering signal may include a trigger frame, such as a null-data frame.

The triggering signal is provided when a triggering interval timer expires. In operation, the triggering interval timer may be set after it expires, and, again, reset after interpreting fields in downlink frames, including the End of Service Period (EOSP) and MoreData fields.

In effect, the present invention provides a transmission rule of trigger frames in order to achieve energy efficient delivery in U-APSD defined in IEEE 802.11e. It deals with when to start and how to start trigger frames' transmission, called triggering rules herein. The basic idea of the present invention is to define certain triggering rules for the STA to send activation indication/trigger frames to AP so that the power saving vs. data throughput ratio of the communication is optimized. The idea is that the STA maintains a timer dedicated timer that defines the schedule when to initiate transmissions of a null-data frame as a trigger frame if there's no actual data to send by the STA.

The parameters that affect the timer value may include:
uplink data transmissions,
currently used service/application, and/or
past communication requirements.

So, if the terminal has data to send, the timer may be set accordingly to a minimum value and if there are no data to send, the timer may be set based on the service/application currently in use and/or past communication requirements so that the triggering interval (timer value between transmission of two trigger frames) adapts according to changes in the current communication situation.

The scope of the invention may include a node, point, terminal or device in such a wireless local area network (WLAN) or other suitable network, such as a station (STA). Moreover, the scope of the invention may also include a WLAN chipset for such a node, point, terminal or device in such a wireless local area network (WLAN) or other suitable network, as well as a computer program product with a program code, which program code is stored on a machine readable carrier, for carrying out the steps of the method according to the present invention. The method may also feature implementing the step of the method via a computer program running in a processor, controller or other suitable module in such a WLAN terminal.

In one embodiment, the present invention provides a method for implementing an unscheduled automatic power save delivery (U-APSD) in a wireless local area network (WLAN) terminal, comprising one or more steps for maintaining a timer for defining a triggering interval between sending of subsequent trigger frames to a WLAN access point, wherein the value of the timer is set to dynamically change according to one or more criteria relating to the current communication situation.

### BRIEF DESCRIPTION OF THE DRAWING

The drawing includes the following Figures, which are not necessarily drawn to scale:

FIG. 1 shows typical parts of an IEEE 802.11 WLAN system, which is known in the art.

FIGS. 2a and 2b show diagrams of the Universal Mobile Telecommunications System (UMTS) packet network architecture, which is also known in the art.

FIG. 3 shows a WLAN enabled device according to one embodiment of the present invention.

FIG. 4 shows an exemplary WLAN chip that forms part of the WLAN enabled device shown in FIG. 3 according to one embodiment of the present invention.

FIG. 5 shows a diagram of the basic operations according to one embodiment of the present invention.

FIG. 6 shows a diagram of timer cancellation when sending an uplink data frame according to one embodiment of the present invention.

### BEST MODE OF THE INVENTION

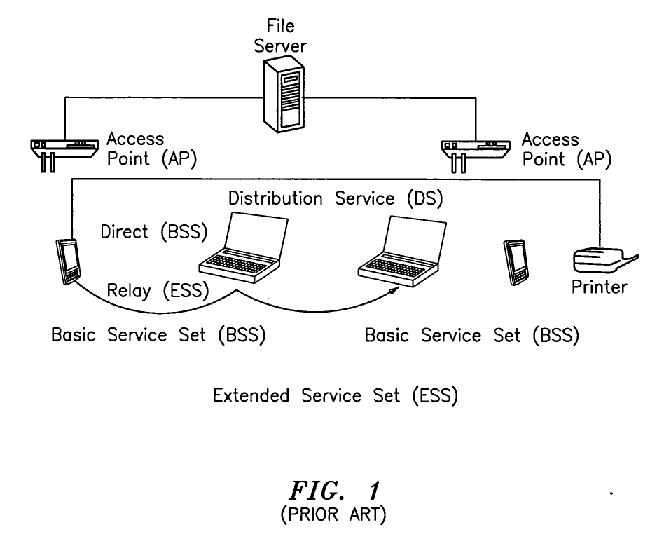

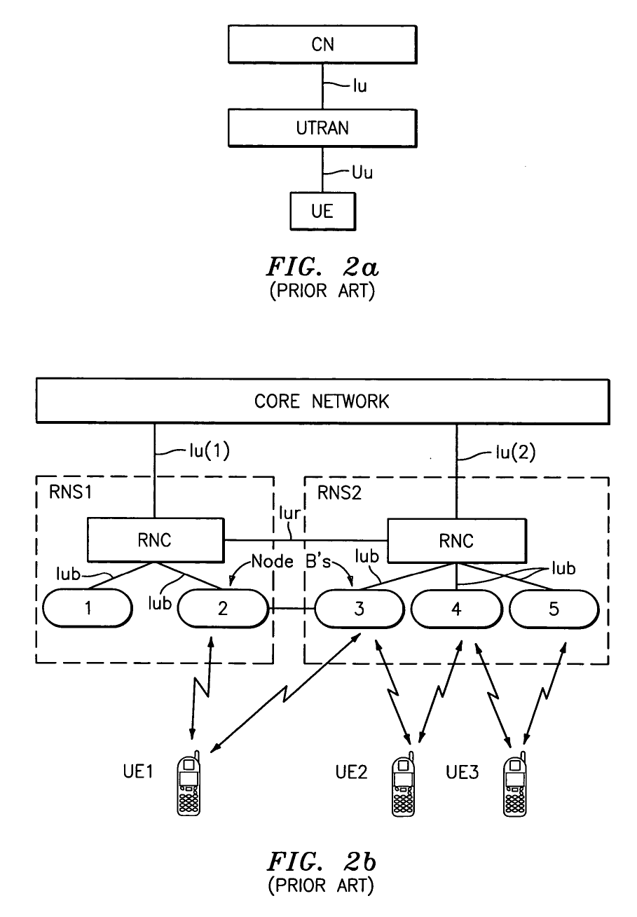

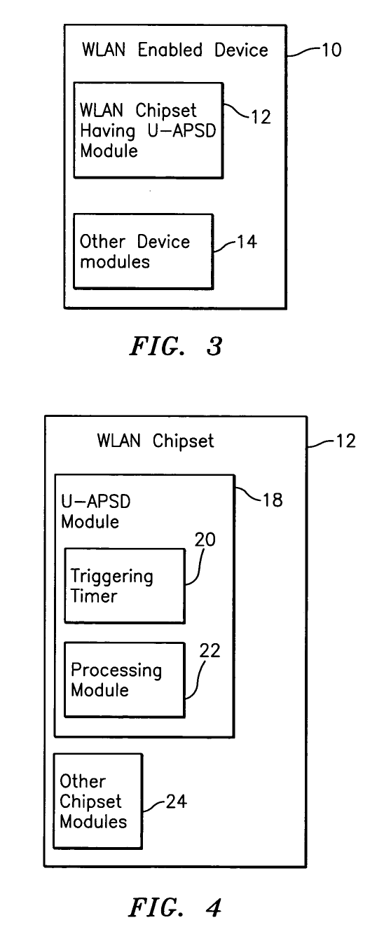

FIG. 3 shows a node, point, terminal or device in the form of a WLAN enabled device generally indicated 10 according to one embodiment of the present invention for a wireless local area network (WLAN) or other suitable network such as that shown in FIGS. 1, 2a and 2b. The WLAN enabled device 10 has a WLAN chipset 12 having a U-APSD module 18 (see FIG. 4) for periodically providing a triggering signal based on a variable triggering interval according to the present invention, as well as other device modules 14. The WLAN enabled device 10 may take the form of a station (STA) or other suitable node, point, terminal or device either now known or developed in the future for operating in such a wireless local area network (WLAN) or other suitable network such as that shown in FIGS. 1, 2a and 2b.

FIG. 4 shows, by way of example, the WLAN chipset 12 in further detail, where the U-APSD module 18 includes a triggering timer 20 and a processing module 22 according to one embodiment of the present invention. In operation, the processing module 22 cooperates with the triggering timer 22 consistent with that shown and described herein for periodically providing a triggering signal based on a variable triggering interval according to the present invention. The WLAN chipset 12 may also include other chipset modules 24 that do not necessarily form part of the underlying invention and are not described in detail herein, including a baseband module, a MAC module, a host interface module. Although the present invention is described in the form of a stand alone module for the purpose of describing the same, the scope of the invention is invention is intended to include the functionality of the U-APSD module 18 being implemented in whole or in part by one or more of these other chipset modules 24. In other words, the scope of the invention is not intended to be limited to where the functionality of the present invention is implemented in the WLAN chipset 12.

### The Basic Implementation

### U-APSD

A Quality of Service (QoS) Station (QSTA), such as 10, using U-APSD has to send a trigger frame to start downlink transmissions from a QAP, such as the AP in FIG. 1. On the receipt of downlink data frames, it interprets an End of Service Period (EOSP) and MoreData field in a MAC header and decides whether it continues to be awake. As for an uplink transmission, the QSTA using U-APSD can decide when to wake up or when to transmit frames as the same as LegacyPS. Uplink frames are treated as trigger frames to start U-APSD SP (Service Period). If there are no uplink frames, the QSTA transmits a null-data frame as a trigger frame. In 802.11e, there are four ACs (Access Category). To inform the QAP of using U-APSD for an AC, the QSTA has to notify the QAP of which AC is used for U-APSD through (re) association frame transmission. At the QAP an AC, which uses U-APSD, is called a deliver-enabled AC, and at the QSTA an AC, which uses U-APSD, is called a trigger-enabled AC.

If all of the ACs at the QAP are not delivery-enabled, the QAP does not inform a QSTA of the presence of buffered frames in delivery-enabled buffers using TIM (Traffic Indication Map). Therefore, the QSTA has to periodically transmit the null-data frame as a trigger frame if frames for uplink transmissions are not in its transmission buffers.

### Triggering Rule

When using U-APSD in an AC, the downlink transmission is started on the receipt of a trigger frame at the QAP. The 802.11e standard has defined a downlink transmission for a power-saving STA. On the contrary, there is no rule for uplink transmission. Therefore this IPR supposes that uplink transmission is allowed at any time and uplink frames contends for the channel access as soon as possible.

When a QSTA begins a U-SP to retrieve buffered frames, it needs to transmit a trigger frame (uplink data or null-data frame) as specified in U-APSD. If there is no uplink frame, it has to send a null-data frame as a trigger frame in order to initiate a U-SP (Unscheduled SP).

Therefore, the basic idea behind the present invention is that a QSTA maintains a timer, which is called triggering timer 20, in order to periodically initiate transmissions of a null-data frame as a trigger frame and that if the QSTA has no uplink frame at the expiration of the triggering timer, it transmits a null-data frame to begin an Unscheduled Service Period (U-SP). With the use of null-data frames, the present invention is fully compatible with U-APSD defined in IEEE 802.11e. Since the trade-off between saving energy and a small delay has to be balanced, an interval (called triggering interval) between consecutive triggering timers has to be carefully chosen. However, it is very difficult for QSTAs to predict arrivals of downlink packets at a QAP and so it is very difficult to completely optimize the triggering interval. In order to balance the trade-off, the triggering interval can be varied in the present invention. The basic strategy to decide a triggering interval is that after noticing that there are buffered frames at the QAP, the QSTA sets the triggering interval to a minimum one and frequently sends null-data frames to quickly retrieve them, and that when there is no buffered frame at the QAP, the QSTA sets the triggering interval to a larger one to continue the doze/power save mode for a longer time to save energy. Besides, when the STA increases the triggering interval, it is incremented in a binary exponential fashion like a back-off counter. If Ttr denotes a triggering interval, it is incremented like the following: Ttr=2×Ttr. Hence, if there is no buffered frame at the QAP, the triggering interval becomes a large value substantially rapidly, and so the QSTA can continue to sleep for a long time between subsequent transmissions of trigger frames.

One strategy to determine the minimum and maximum values is as follows:

1) Set a maximum value to one typically used as beacon interval, e.g. 100 ms or 200 ms. In addition, also the average OFF period of traffic can be counted when determining the maximum value for the timer.

2) Exponentially decrease the value of the triggering interval starting from the maximum value in order to set a minimum value. And the minimum value should be close to Voice packet generating interval (for example 20 ms). However, it should be less than the voice packet generating interval. If one assumes the beacon interval is 100 ms, then the maximum value is 100 ms. If one assumes the voice packet is generated at every 20 ms during its ON period, then minimum value may be chosen as 12.5 or 6.25 ms.

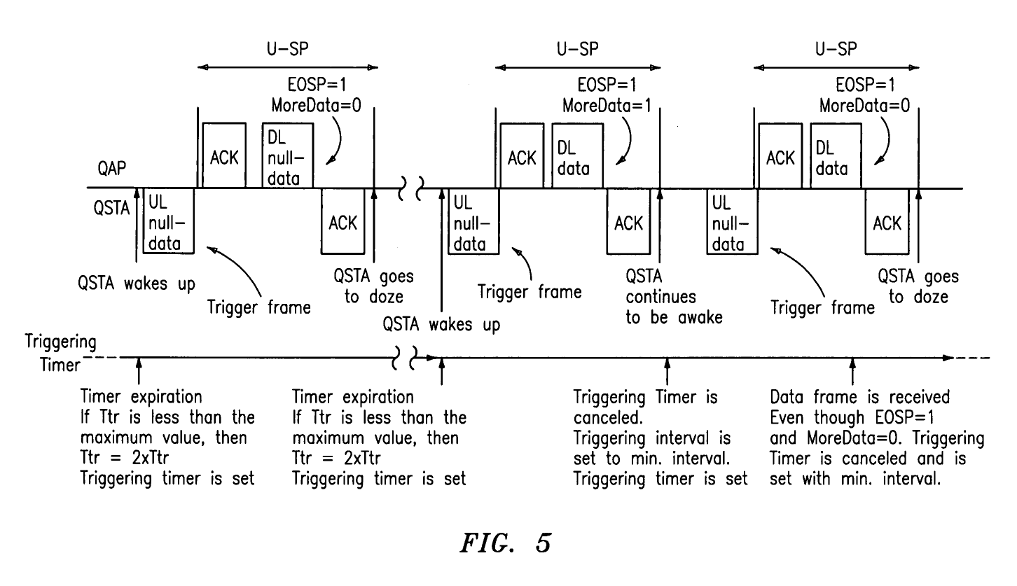

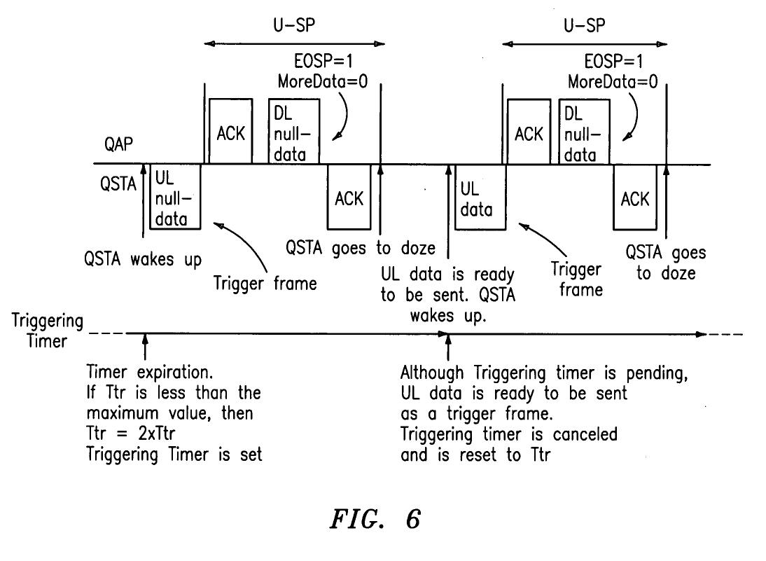

FIGS. 5 and 6 show examples of frame exchange sequence and triggering timer 20 operations according to various embodiments of the present invention. The triggering interval, Ttr, can be varied from minimum to maximum value. In the below, detailed operations of this proposal are described.

If a QSTA decides that U-APSD is used for certain AC or ACs, a triggering timer is set to a maximum interval when the WLAN device starts to work. As shown in FIG. 5, at the expiration of a trigger timer, the QSTA becomes awake and a null-data frame is transmitted. However, if it has buffered uplink data frames, it does not send a null-data frame since those buffered data frames can be trigger frames. Regardless of whether or not a null-data frame is transmitted, the triggering interval is incremented by doubling it, but not beyond the maximum value, and the QSTA sets the triggering timer and waits for downlink frames.

The reason why the triggering timer is set just after the expiration of the timer is as following. If it is set after interpreting EOSP and MoreData fields in received downlink frames, it cannot be set when transmissions of downlink frames are failed. Therefore, the triggering timer is set just after the expiration of the timer, and it is, again, reset after interpreting EOSP and MoreData fields in downlink frames.

How to reset the triggering interval when interpreting these fields is shown in the following. On the receipt of downlink frames from the QAP, the QSTA checks EOSP and MoreData field in the MAC header. Since an EOSP set to 0 means that the U-SP does not end and further downlink frames will come from the AP, the STA continues to be awake and waits for downlink frames. In the case of the EOSP=1 and MoreData=1, the QSTA transmits a trigger frame to the QAP to quickly retrieve buffered frames. Before transmitting it, the QSTA confirms whether there are buffered uplink frames. If there is no buffered frame, the QSTA sends a null-data frame as a trigger frame. Otherwise, a buffered frame will be transmitted as a trigger frame. In the example shown in FIG. 5, a null-data frame is sent as a trigger frame, then the QSTA clears a pending timer and resets the timer with the triggering interval set to a minimum one. This is because it is better to retrieve frames buffered at the QAP as soon as possible. In the case of EOSP=1 and MoreData=0, the QSTA can enter into the doze mode if there is no uplink frame. However, if the received frame is a data frame, the QSTA sets the triggering interval to a minimum one and resets the triggering timer as shown in FIG. 5. This is due to the fact that data frames of real-time flows periodically arrive at the QAP. On the other hand, if the received frame is a null-data frame (i.e., even though the QAP receives a trigger frame and a U-SP starts, the QAP has no buffered data destined for the corresponding QSTA. In this case, the QAP sends a null-data frame with EOSP=1 and MoreData=0 to end the U-SP.), the QSTA can go to the doze mode and continue to sleep until a triggering timer expires or it has uplink data frame. As mentioned above, QSTAs can begin uplink data transmissions at any time in U-APSD. Therefore, when an uplink data frame comes into the transmission buffer at a QSTA and can be transmitted as a trigger frame, the triggering timer is canceled and just reset to Ttr, as presented in FIG. 6. In this case, the Ttr is not updated and is the same as the value which was used by the canceled triggering timer.

In operation, since a QSTA maintains a triggering timer to periodically transmit a null-data frame as a trigger frame, it can quickly retrieve data frames buffered at a QAP even though U-APSD is used for ON-OFF traffic. Furthermore, since the triggering interval is increased in binary exponential manner when there is no frame buffered at the QAP, energy is efficiently saved. Besides, a null-data frame is transmitted only when the STA has no uplink frame, and thus even if the present invention is used for bidirectional real-time traffic generated at a constant bit rate, many null-data frames do not have to be transmitted. Therefore, it is applicable for bidirectional traffic generated at a constant bit rate.

The scope of the invention is also intended to include embodiment where the variable triggering interval may include minimum and maximum values that are based on the currently used application/service. For example, if one knows traffic characteristics, then the timer value may be defined according to such characteristics.

### Implementation of the Functionality of U-APSD Module 18

By way of example, and consistent with that described herein, the functionality of the U-APSD module 18 may be implemented using hardware, software, firmware, or a combination thereof, although the scope of the invention is not intended to be limited to any particular embodiment thereof. In a typical software implementation, the module 18 would be one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology now known or later developed in the future. Moreover, the scope of the invention is intended to include the module 18 being a stand alone module, as shown, or in the combination with other circuitry for implementing another module. Moreover, the real-time part may be implemented in hardware, while non real-time part may be done in software.

The other chipset modules 24 may also include other modules, circuits, devices that do not form part of the underlying invention per se. The functionality of the other modules, circuits, device that do not form part of the underlying invention are known in the art and are not described in detail herein.

### The WLAN Chipset

The present invention may also take the form of the WLAN chipset 12 for a node, point, terminal or device in a wireless local area network (WLAN) or other suitable network, that may include a number of integrated circuits designed to perform one or more related functions. For example, one chipset may provide the basic functions of a modem while another provides the CPU functions for a computer. Newer chipsets generally include functions provided by two or more older chipsets. In some cases, older chipsets that required two or more physical chips can be replaced with a chipset on one chip. The term “chipset” is also intended to include the core functionality of a motherboard in such a node, point, terminal or device.

### List of Abbreviations

QSTA: QoS Station
QAP: QoS Access Point
U-APSD: Unscheduled Automatic Power Save Delivery
SP: Service Period
EOSP: End of Service Period
U-SP: Unscheduled Service Period

### Scope of the Invention

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

1. A method for implementing an unscheduled service period (U-SP) in a node, point, terminal or device, such as a station (STA), in a wireless local area network (WLAN), or other suitable network, wherein the method comprises periodically providing a triggering signal based on a variable triggering interval.

2. A method according to claim 1, wherein the variable triggering interval depends on whether there are buffered frames at another node, point, terminal or device, such as an Access Point (AP), in the wireless local area network (WLAN), or other suitable network.

3. A method according to claim 2, wherein,
when there are buffered frames at the AP, the STA sets the triggering interval to a minimum value to quickly send null-data frames to retrieve said buffered frames, or
when there is no buffered frame at the AP, the STA sets the triggering interval to a larger value to continue the doze mode for a longer time to save energy.

4. A method according to claim 1, wherein the STA incrementally increases the triggering interval in a binary exponential fashion.

5. A method according to claim 1, wherein the triggering interval is varied by incrementally doubling it, but not to exceed a maximum value.

6. A method according to claim 1, wherein the triggering signal is provided when a triggering interval timer expires.

7. A method according to claim 6, wherein the triggering interval timer is set after it expires, and/or the triggering interval timer is, again, reset after interpreting fields in downlink frames, including the End of Service Period (EOSP) and MoreData fields.

8. A method according to claim 1, wherein the variable triggering interval includes minimum and maximum values are based on the currently used application/service.

9. A node, point, terminal or device, such as a station (STA), for implementing an unscheduled service period (U-SP) in a wireless local area network (WLAN) or other suitable network, wherein
the node, point, terminal or device has a module that is configured for periodically providing a triggering signal based on a variable triggering interval.

10. A node, point, terminal or device according to claim 10, wherein the variable triggering interval depends on whether there are buffered frames at another node, point, terminal or device, such as an Access Point (AP)), in the wireless local area network (WLAN), or other suitable network.

11. A node, point, terminal or device according to claim 10, wherein,
when there are buffered frames at the AP, the STA sets the triggering interval to a minimum value to quickly send null-data frames to retrieve said buffered frames, or
when there is no buffered frame at the AP, the STA sets the triggering interval to a larger value to continue the doze mode for a longer time to save energy.

12. A node, point, terminal or device according to claim 9, wherein the STA incrementally increases the triggering interval in a binary exponential fashion.

13. A node, point, terminal or device according to claim 9, wherein the triggering interval is varied by incrementally doubling it, but not to exceed a maximum value.

14. A node, point, terminal or device according to claim 9, wherein the triggering signal is a trigger frame, including a null-data frame.

15. A node, point, terminal or device according to claim 9, wherein the triggering signal is provided when a triggering interval timer expires.

16. A node, point, terminal or device according to claim 15, wherein the triggering interval timer is set after it expires, and/or the triggering interval timer is, again, reset after interpreting fields in downlink frames, including the End of Service Period (EOSP) and MoreData fields.

17. A node, point, terminal or device according to claim 9, wherein the variable triggering interval includes minimum and maximum values are based on the currently used application/service.

18. A WLAN chipset for implementing an unscheduled automatic power save delivery (U-APSD) in a node, point, terminal or device, including a station (STA), in a wireless local area network (WLAN) or other suitable network, wherein
the WLAN chipset has a module that is configured for periodically providing a triggering signal based on a variable triggering interval.

19. A WLAN chipset for according to claim 18, wherein the variable triggering interval depends on whether there are buffered frames at another node, point, terminal or device, such as an Access Point (AP), in the wireless local area network (WLAN), or other suitable network.

20. A WLAN chipset according to claim 19, wherein,
when there are buffered frames at the AP, the WLAN chipset sets the triggering interval to a minimum value to quickly send null-data frames to retrieve said buffered frames, or
when there is no buffered frame at the AP, the WLAN chipset sets the triggering interval to a larger value to continue the doze mode for a longer time to save energy.

21. A WLAN chipset according to claim 18, wherein the STA incrementally increases the triggering interval in a binary exponential fashion.

22. A WLAN chipset according to claim 18, wherein the triggering interval is varied by incrementally doubling it, but not to exceed a maximum value.

23. A WLAN chipset according to claim 18, wherein the variable triggering interval includes minimum and maximum values are based on the currently used application/service

24. A computer program product with a program code, which program code is stored on a machine readable carrier, for carrying out the steps of a method for implementing an unscheduled automatic power save delivery (U-APSD) by periodically providing a triggering signal based on a variable triggering interval, when the computer program is run in a module of either a node, point, terminal or device, such as a station (STA).

25. A method according to claim 1, wherein the method further comprises implementing the step of the method via a computer program running in a processor, controller or other suitable module in one or more network nodes, points, terminals or elements in the wireless LAN network.

26. A method for implementing an unscheduled automatic power save delivery (U-APSD) in a wireless local area network (WLAN) terminal, comprising:
maintaining a timer for defining a triggering interval between sending of subsequent trigger frames to a WLAN access point, wherein the value of the timer is set to dynamically change according to one or more criteria relating to the current communication situation.

27. A method according to claim 26, wherein the criteria depend on whether there are buffered frames at another node, point, terminal or device, such as an Access Point (AP)), in the wireless local area network (WLAN), or other suitable network.

28. A method according to claim 27, wherein,
when there are buffered frames at the AP, the WLAN terminal sets the triggering interval to a minimum value to quickly send null-data frames to retrieve said buffered frames, or
when there is no buffered frame at the AP, the STA sets the triggering interval to a larger value to continue the doze mode for a longer time to save energy.

29. A method according to claim 26, wherein the WLAN terminal incrementally increases the triggering interval in a binary exponential fashion, including doubling it, but not exceeding a maximum value.

30. A method according to claim 26, wherein the one or more criteria is further based on the:
the currently used service/application, and/or
the past communication requirements.

31. Apparatus comprising:
one or more modules for implementing an unscheduled service period (U-SP) in a node, point, terminal or device, such as a station, in a wireless local area network or other suitable network, the one or more modules being configured for periodically providing a triggering signal based on a variable triggering interval.

32. Apparatus according to claim 31, wherein the variable triggering interval depends on whether there are buffered frames at another node, point, terminal or device, such as an Access Point (AP), in the wireless local area network (WLAN), or other suitable network.
